(19) United States
(12) Patent Application Publication
(10) Pub. No.: US 2008/0288382 A1
(43) Pub. Date: Nov. 20, 2008

(54) Methods and Systems for Early Fraud Protection

(76) Inventors: Steven B. Smith, Holladay, UT (US); Nicholas A. Thomas, Orem, UT (US); Warren Rosner, South Jordan, UT (US); Jay Brett McCleary, West Valley City, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/749,135

(22) Filed: May 15, 2007

(51) Int. Cl. G06Q 40/00

(52) U.S. Cl. 705/35

(57) ABSTRACT

Embodiments of the invention provide for improved early detection of fraud through user-defined monitoring of financial account information and communication of alerts and notifications of user-defined individualized potentially-fraudulent account activity to users. Embodiments of the invention permit an account fraud detection service provider to provide account monitoring services. The user may use the fraud detection service provider to monitor any number and type of financial accounts, and the user may define account notification rules or filters under which the user may choose to be notified of certain potentially-fraudulent account activities. The user may receive alerts and/or notifications of the user-selected account activities using a method selected by the user, and may therefore maintain awareness of account activities and be alerted of any troubling activity in a manner most convenient and effective for the user's needs.

### BACKGROUND OF THE INVENTION

1. Field of the Invention

The present invention relates to improved communication to consumers of financial account activity, and more particularly to such communications provided by a third-party fraud protection service according to user-defined alert filter criteria.

2. Background and Related Art

The incidence of identity theft, theft of financial information, and other related ills has greatly increased in recent times. The damage inflicted on individuals, businesses, and financial institutions from such crimes and other unauthorized uses of is extensive and expensive. In many instances, individuals may fight for years to repair their credit histories and may fight in vain to recover even a small portion of lost monies.

Some current systems have been devised to attempt to prevent or limit losses due to such illicit activity. For example, credit card companies may employ detection systems and algorithms designed to detect unusual activity. Such systems rely on credit-card-company definitions of unusual activity, and may prompt the credit card company to call a card holder to confirm whether the card activity is authorized or is a symptom of illicit use. Unfortunately, such systems are slow to detect unusual usage patterns and in some instances may fail to detect and prevent fraud until after much damage has already occurred. As another example, automated teller machines (ATMs) often prevent users from withdrawing more than a fixed amount of cash from the users' accounts to prevent a criminal from quickly depleting a customer's accounts. However, many criminals simply make small withdrawals from numerous ATMs in a short period of time, often in off-business hours, before the criminal activity can be detected and the customers' accounts frozen.

Criminals of many types have also learned how to avoid triggering currently-available fraud detection systems. Well-informed criminals who steal an individual's identity, financial information, credit cards, debit cards, etc. have therefore learned how to maximize the financial gain they can obtain (and financial damage they can cause) before triggering fraud detection systems that limit or discontinue the criminals' financial gain. Therefore, the currently-available fraud detection systems have proven limited and inflexible at rapidly detecting and limiting fraudulent activity.

### BRIEF SUMMARY OF THE INVENTION

Embodiments of the invention provide for improved user-defined monitoring of financial account information and communication of alerts and notifications of fraudulent activity to users. Embodiments of the invention permit a fraud detection service provider to provide account monitoring services. The user may use the fraud detection service provider to monitor any number and type of financial accounts, and may define user-specific account notification rules, filters, or criteria under which the user may choose to be notified of certain account activities. The user may receive alerts and/or notifications of the user-selected account activities using a method selected by the user, and may therefore maintain awareness of account activities and be alerted of any troubling activity and/or any other desired account activity in a manner most convenient and effective for the user's needs.

In embodiments of the current invention, the monitoring service may be provided as a stand-alone product or service by the fraud detection service provider, or it may be offered as a part of a more-complete financial service package. Using embodiments of the current invention, a user's experience may be limited to an initial interaction to establish accounts and criteria for monitoring, followed by receipt of account notification messages whenever activity falling within or without the account notification criteria occurs. The user may continue receiving those notifications indefinitely with little or no further direct interaction by the user with the fraud detection service provider account notification setup services. Upon receiving an account notification in accordance with embodiments of the present invention, the user may interact directly with the financial services account holder for which the notification was generated to take any necessary action.

In some embodiments, the fraud detection service provider may provide account monitoring services and notifications while also providing the users with opportunities to respond to notifications. When a response is received, it may indicate that a particular transaction is approved, future transactions with a particular vendor are approved, future transactions of a particular type are approved, etc. In this way, the fraud detection service may essentially improve its monitoring services and the user's filters over time so as to limit unnecessary notifications and improve the user's experience.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a configuration of a representative computer device that may be used in accordance with embodiments of the present invention;

FIG. 2 shows a representative networked computer system suitable for use with embodiments of the invention;

FIG. 3 shows a representative network computer configuration suitable for use with embodiments of the invention;

FIG. 4 shows a flow chart of establishing and modifying account notification rules in accordance with embodiments of the present invention;

FIG. 5 shows a notification in accordance with embodiments of the present invention; and

FIG. 6 shows another notification in accordance with embodiments of the present invention.

### DETAILED DESCRIPTION OF THE INVENTION

A description of the embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide for improved user-defined monitoring of financial account information and communication of alerts and notifications of fraudulent activity to users. Embodiments of the invention permit a fraud detection service provider to provide account monitoring services. The user may use the fraud detection service provider to monitor any number and type of financial accounts, and may define user-specific account notification rules, filters, or criteria under which the user may choose to be notified of certain account activities. The user may receive alerts and/or notifications of the user-selected account activities using a method selected by the user, and may therefore maintain awareness of account activities and be alerted of any troubling activity and/or any other desired account activity in a manner most convenient and effective for the user's needs.

In embodiments of the current invention, the monitoring service may be provided as a stand-alone product or service by the fraud detection service provider, or it may be offered as a part of a more-complete financial service package. Using embodiments of the current invention, a user's experience may be limited to an initial interaction to establish accounts and criteria for monitoring, followed by receipt of account notification messages whenever activity falling within or without the account notification criteria occurs. The user may continue receiving those notifications indefinitely with little or no further direct interaction by the user with the fraud detection service provider account notification setup services. Upon receiving an account notification in accordance with embodiments of the present invention, the user may interact directly with the financial services account holder for which the notification was generated to take any necessary action.

In some embodiments, the fraud detection service provider may provide account monitoring services and notifications while also providing the users with opportunities to respond to notifications. When a response is received, it may indicate that a particular transaction is approved, future transactions with a particular vendor are approved, future transactions of a particular type are approved, etc. In this way, the fraud detection service may essentially improve its monitoring services and the user's filters over time so as to limit unnecessary notifications and improve the user's experience.

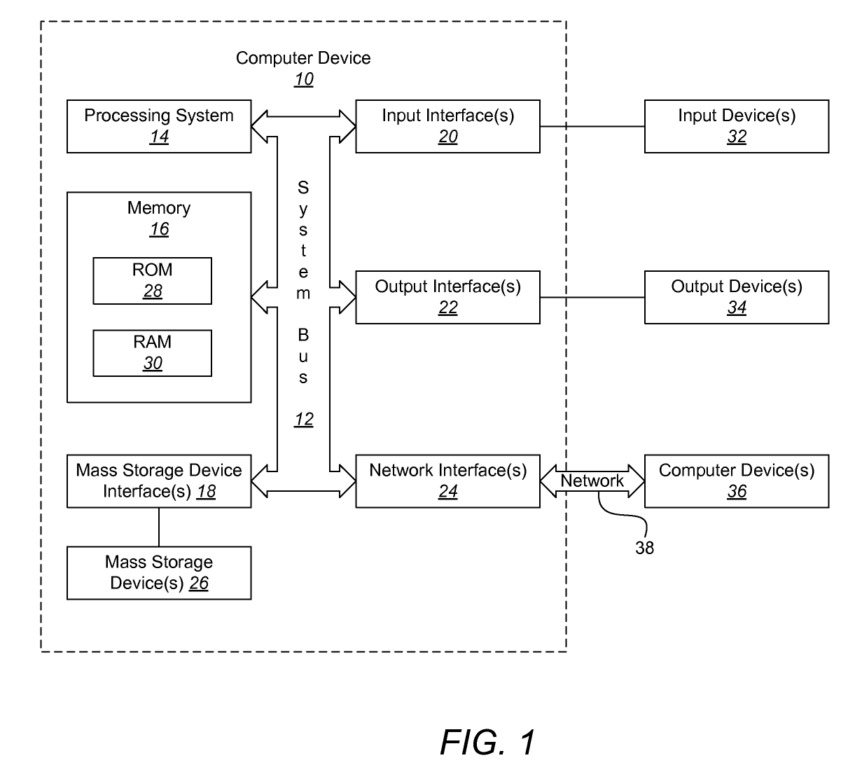

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs single- or multi-colorant rendering. In another embodiment, the system configuration includes one or more client computer devices, optionally one or more server computer devices, and a connection or network communication that enables the exchange of communication to an output device, which is configured to perform multi-colorant rendering.

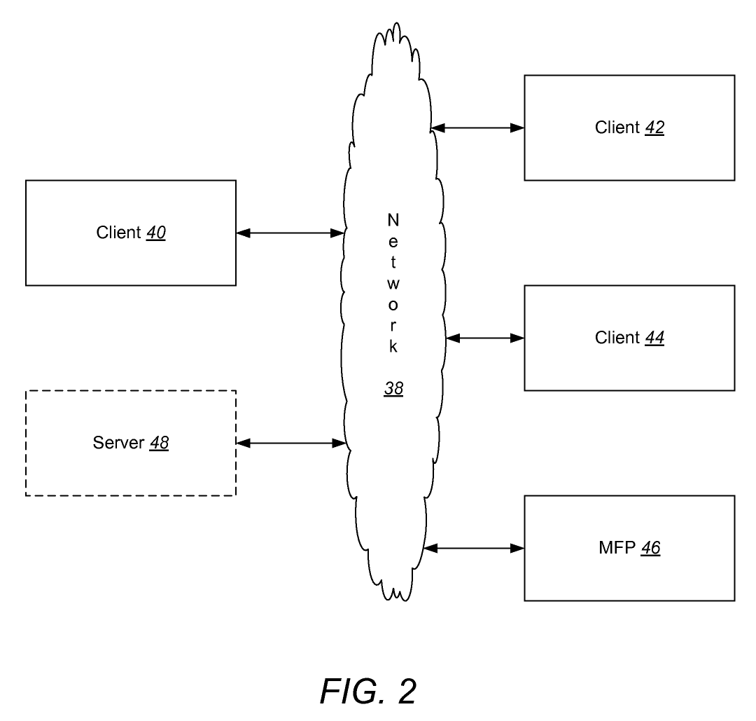

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

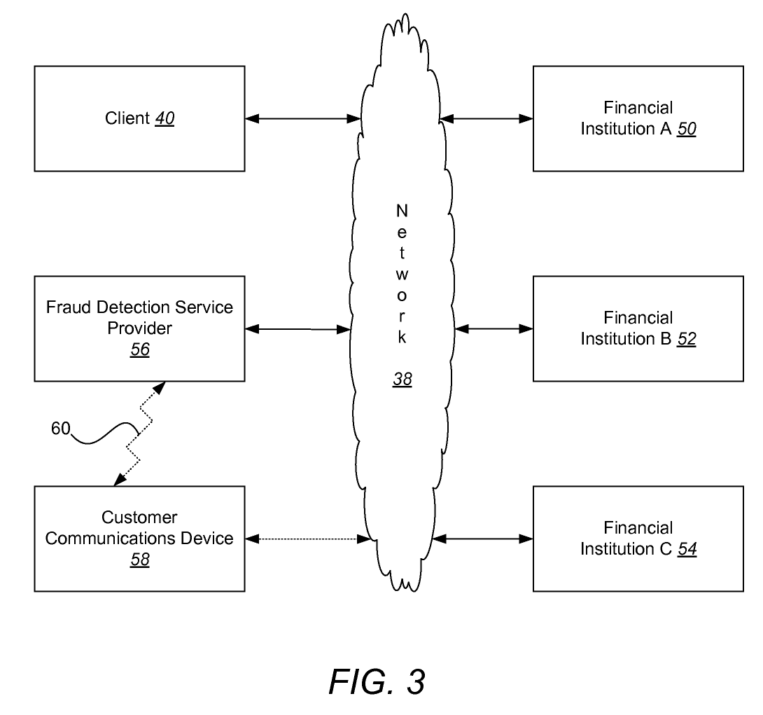

FIG. 3 illustrates one illustrative networked system configuration that may be used with embodiments of the present invention. The representative system includes a computer device, illustrated as client 40, which is connected to the network 38. The client 40 may be continuously or intermittently connected to the network 38, and may have one or more applications running on the client 40. Various financial institutions, such as banks, credit card companies, credit unions, mortgage and other lenders, and any other institution that may have a consumer financial account may also be connected to the network, and are represented as financial institution A 50, financial institution B 52, and financial institution C 54. In some embodiments, the various financial institutions may provide users with an Internet-accessible web page accessible through the network 38. In such configurations, a person having a financial account at a financial institution such as financial institution A 50 may access information about the user's financial account using the financial institution's network-accessible web page, usually using an authentication procedure such as entering a username and password and/or answering a challenge question.

Some users, however, may find it disadvantageous to visit the websites of the users' various financial institutions with any degree of regularity. This may especially be the case where the users have multiple financial accounts at multiple financial institutions, as some users may find it inconvenient to navigate to the various websites and to perform multiple authentication procedures. This problem may be alleviated to some degree by using a third-party service provider to access users' account information at various institutions, compile the information, and present the information in a user-friendly format. In some embodiments, the third-party service provider may check for updated information on a regular schedule, such as daily or hourly. Such third-party providers are sometimes known as aggregators, and FIG. 3 shows one third-party fraud detection service provider 56 connected to the network 38. Although each of the various financial institutions 50, 52, and 54 and the fraud detection service provider 56 are represented as a single entity connected to the network 38 in FIG. 3, one of skill in the art will readily recognize that each of these entities may include a plurality of computer devices and network connections and may include computer devices widely distributed around the world and linked through the network 38 or through a proprietary secured network (not shown).

The fraud detection service provider 56 may provide the compiled information to users in various forms using various methods of communication. In some embodiments, the fraud detection service provider's information may be provided through a stand-alone application residing on the user's client 40. In such embodiments, when the user accesses the program on the client 40, the application may automatically connect to the fraud detection service provider 56 to determine if any updated information is available. Alternatively, the user can request a check for updated information. Also, in some embodiments, the user may take an action that requests the fraud detection service provider 56 to obtain updated information from the user's financial institutions.

In other embodiments, the fraud detection service provider may provide the compiled information through a network portal and network application, such as on a website. In such embodiments, the user need not have a stand-alone application on the user's computer device(s), but may access the information through the fraud detection service provider 56 from any network-connected (i.e. Internet-connected) computer device. In some embodiments, the fraud detection service provider 56 may provide additional financial services to users, such as budgetary and accounting software services, etc. Regardless of the manner in which the users access the information provided by the fraud detection service provider 56, the information may include detailed transactional information so as to be of most use to the users.

In some embodiments, a user may request that the fraud detection service provider 56 provide notifications of certain events to the user, such as events indicative of fraudulent activity. Such notifications may be delivered as an alert within the stand-alone program, when the user logs in to the user's account provided by the fraud detection service provider 56, by e-mail, by text message, by automated telephone call, or by any other delivery method. These notifications may be delivered to the user through the client 40, or through a separate communications device. Therefore, FIG. 3 also illustrates a customer communications device 58. The customer communications device 58 may be any device that can receive a notification of events, and may include a landline telephone, a cell phone, a smart phone, a personal digital assistant (PDA), a pager, a laptop computer, or any other similar device. The customer communications device 58 may be connected to the network 38, or it may receive the notifications through some other mechanism, such as through any other networked or non-networked communication mechanism, illustrated as wireless connection 60. In some embodiments, notifications may be provided simultaneously or sequentially by one or more of the above methods to one or more customer communications devices 58.

Using embodiments of the present invention, a user can customize the alerts the customer receives in a manner previously unavailable, and may do so through a single unified provider, namely a fraud detection service provider such as fraud detection service provider 56. The user may customize the types of notices received and may further customize the manner in which the notices are received. In this way, a user may have greater control and awareness of activities occurring with his or her accounts than previously possible. In customizing the alerts the user receives, the user essentially defines filters that the fraud detection service provider may apply to new transactions on the user's accounts to determine when notification of account activity should be provided. When application of the filter conditions results in a matching account activity (or, conversely, in an account activity that does not match, depending on the type of filter created), a notification may be generated and provided to the user.

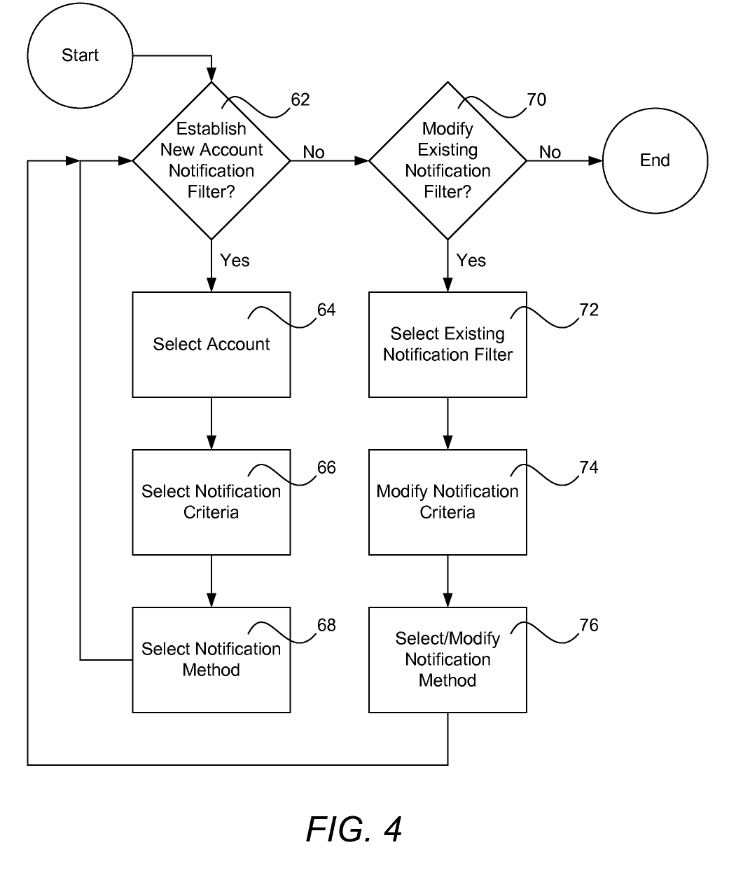

An example of establishing an account notification filter will be provided with reference to FIG. 4. Before the steps illustrated in FIG. 4 occur, a user may have established an account with a fraud detection service provider such as fraud detection service provider 56. As described, the account may be accessed through a stand-alone application on a computer device of the user or may be accessible through a web-based application or portal, for example. The user may have also selected at least one account at a financial institution to monitor using the fraud detection service provider, and may have entered information allowing the fraud detection service provider to access the user's account information at the financial institution. If not, these steps may be performed prior to, after, or concurrently with the steps illustrated in FIG. 4.

In FIG. 4, execution begins with decision block 62, where the user decides whether or not to establish a new account notification filter. If the user decides to establish a new account notification filter, execution proceeds to step 64, where the user may select an account or a plurality of accounts for which the new notification procedure should be applied. By way of example, the user may select a single credit card account for which the new notification rules and procedures should apply, or may select to apply the new notification rules and procedures to all credit card accounts, or a selection of the user's credit card accounts. Once the user has selected one or more accounts for the new notification, the user may then be prompted to select notification criteria at step 66.

Embodiments of the invention provide for a wide array of user-selected notification criteria, and any type of user notification criteria is embraced by the embodiments of the invention. Notification criteria may be inclusive (i.e., the user may select to be notified when a certain type of event occurs), or the notification criteria may be exclusionary (i.e., the user may select to be notified whenever an account activity falls outside of a certain set of defined activities), or the notification criteria may include inclusive criteria mixed with exclusive criteria. By way of example, and not limitation, the user may select to be notified when a transaction is recorded having a value exceeding a certain amount. This type of notification may be applied to savings accounts, credit card accounts, checking accounts, money market accounts, mutual fund accounts, other stock market accounts, mortgage accounts, etc.

A user may also select to be notified when a transaction occurs with a specific payee. The user may also select to be notified of any transactions occurring within or without a certain geographic region. For example, a user may select to be notified of any transactions occurring in a foreign country (in general or in a particular foreign country) or requiring foreign exchange fees as being indicative of credit card fraud or identity theft. A user might also select to be notified of any transactions occurring within or without a certain state. A user may select to be notified of all ATM-based transactions or cash advances. A user may also select to be notified of any transaction involving a new payee not previously cleared by the user. A user may also select to be notified based on the number of transactions per day, whether within a single account or across multiple accounts. A user could also select to be notified when an account balance exceeds a certain amount or drops below a certain amount. A user could also select to be notified when a check number outside of a certain range or sequence clears. These examples are provided by way of illustration, and are not meant to be limiting. One of skill in the art will readily recognize the many different types of notification criteria that could be selected by a user. Any filter criteria may be selected by the user and defined by the user to permit early fraud detection of the user's accounts according to the user's own knowledge of what activities are typical and atypical for the individual user.

In some embodiments, a user may specify the frequency with which the account(s) should be checked for new account activity and the frequency with which the notification criteria should be applied and notifications issued to the user. The user may also select the rapidity with which the user should be notified of account activity. For example, a user may select to be notified immediately of certain types of account transactions, and may select to be notified on a fixed schedule for other types of account transactions, perhaps in a daily summary notification. A user may select to be notified of all transactions for one or more selected accounts. The user may also select any number of criteria and apply them jointly to determine when a notification should be made. One of skill in the art will readily appreciate the many notification criteria that may be selected and applied singly or together in step 66.

Once the user has selected the criteria for notification, the user may also select one or more methods for notification of the account activity at step 68. Such methods of notification may include, without limitation, e-mail, automatic telephone call, text message, notification in a stand-alone computer program/application, or any other method or manner for notification, including any combination of the above. In some embodiments, the fraud detection service provider may offer to have a live individual contact the user for notification purposes for an extra cost, with the added benefit that the fraud detection service provider's employee will be able to confirm that the notification was received by the intended user. The user may, of course, specify the contact information (telephone number(s), e-mail address(es), etc.) used for each notification. In this way, the user may ensure notifications are promptly and conveniently received of account activity. Once the user has entered the notification criteria and the notification method, a new account notification rule or filter may be saved by the fraud detection service provider and the user may promptly begin receiving notifications according to the account notification rule or filter.

Execution then returns to step 62, where the user may select to establish an additional account notification filter. When the user selects not to establish a new account notification filter, execution may proceed to decision block 70, where the user may be presented with a choice of modifying an existing account notification rule or filter. Alternatively, in some embodiments, the user may be allowed to duplicate an existing rule and then modify the duplicate rule to apply similar or identical rules to various accounts, or to apply slightly different rule criteria to a single account or group of accounts. In any event, if a user decides to modify an existing rule or filter (duplicated or not), execution proceeds to step 72, where the user selects an existing account notification rule or filter to modify.

When the selection has been made, the user is then allowed to modify, add, or delete notification criteria at step 74. As may be readily appreciated, any type of modification may be made and fall within the scope of the present invention. The user may then select and/or modify the notification method at step 76, upon which selection or modification, the modified account notification rule or filter may be saved by the fraud detection service provider and may then take effect. When all desired account notification rules or filters have been added and/or modified, execution ends.

The user may then receive account notifications according to the self-defined user criteria established at steps 66 and 74. The account notifications may be provided without any further interaction between the user and the fraud detection service provider, except as desired by the user to add/delete/modify account notification rules or filters and criteria and/or to access other features provided by the fraud detection service provider. Once the account notification rules have been established, the user may simply receive account notifications of account activity, and may take any necessary action relating to the account notifications by contacting the financial institution holding the affected account. Of course, with any notification received, the user may be aware of and approve the transaction, and may not take any action based on the received notification. In this way, a vast improvement in knowledge and security for many users may be provided by the embodiments of the invention.

As an example, while a single financial institution may choose to notify a user of suspicious activity after some period of time has passed, the definition of suspicious activity may vary from financial institution to financial institution, and the user cannot be sure that the financial institution will timely catch and report suspicious activity in a way that will provide the most benefit to the user. Additionally, activity that a typical financial institution might not determine to be suspicious based on the financial institution's evaluation and experience, may easily be identified by the user as being suspicious using the user's own definition of suspicious activity. Using embodiments of the present invention, the user can rely on the fraud detection service provider to monitor the user's account activity according to user-selected criteria defining what kind of activity is suspicious (or merely of interest) for that particular user, and may be quickly notified of such activity without being required to constantly and frequently log on to each of the user's financial institution's web sites to check each of the user's accounts' histories.

For example, one user may travel a great deal and may not wish to be notified of credit card charges occurring in different countries unless the credit card charges exceed a certain amount. Meanwhile, another user may be less of a traveler, may wish to be notified of any and all transaction occurring outside of his local area, and may additionally choose to be notified of any charges within his local area over a certain amount. Using embodiments of the invention, the first user can easily establish notification criteria based solely on charge amount or may base notification criteria on charge amount and location of charge. Meanwhile, the second user can establish notification criteria based solely on geography as well as separate criteria based on amount or amount and location. Thus, the notifications may be individualized for each user and may therefore provide individualized benefits previously unavailable.

As another example, suppose a user is concerned about the user's balances in several banking (checking and savings) accounts and several credit card accounts. Specifically, the user may be concerned about exceeding his or her credit limits on the credit cards, and may be concerned about banking balances dropping below certain minimums to avoid banking fees or to signal suspicious activity. Such a user may set up notification criteria for each account to receive a notification when the respective balance falls below or rises above certain respective user-defined amounts established for each account. Additionally, in some embodiments, the user may select to receive a daily notification of all the balances of each account in a single notification message, making it easy for the user to know, at a glance, the state of the user's financial affairs. As the notifications may be delivered in several manners defined by the user, a user may be sure of receiving his or her notifications regardless of the location or situation in which the user finds him or herself.

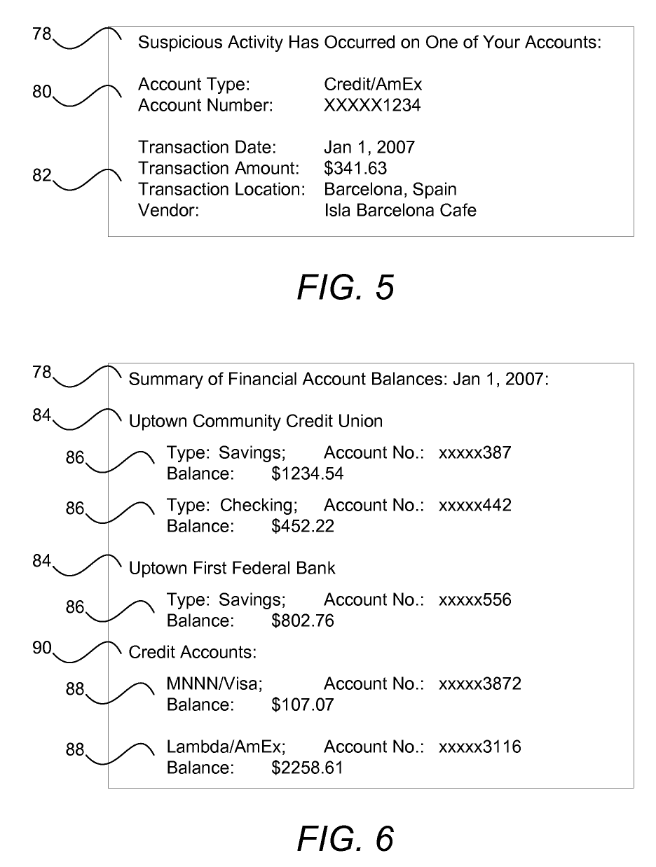

One example of an account notification message is illustrated in FIG. 5. As may be appreciated by reference to FIG. 5, the illustrated notification message may be transmitted as an e-mail message, as a short message service (text) message to a cellular phone or pager, or may be audibly provided by an automated telephone message. In some embodiments, the notification message may be provided to an employee of the fraud detection service provider, who may attempt to contact the user directly. The notification may include a message header 78 indicating the general substance of the notification message. The message header 78 may also be the subject line of an e-mail message containing the notification message. In the illustrated example, the message header 78 is general in nature and merely notifies the user that activity has occurred. In other embodiments, the message header 78 may include additional information, including the type of activity and/or an identification of the rule triggering the account notification method.

The illustrated account notification also includes account identifying information 80. As the user may have multiple accounts being monitored according to various transaction notification rules, the account identifying information 80 may provide the user with immediate knowledge of the affected account. The account identifying information 80 may include any information desired to adequately identify the affected account to the user, and may include an account type such as credit, mortgage, checking, savings, stock, mutual fund, etc. and may also include an identification of the financial institution as a whole or partial account number (with a partial account number being preferred to prevent undesired access to the account information in the case the notification message is inadvertently received by someone other than the intended user). Any other desired or pertinent account identifying information 80 may be included. In the illustrated example, only account type and a partial account number are illustrated.

Immediately below the account identifying information 80, the illustrated notification message includes transaction information 82. The transaction information 82 may include any identifying information desired to adequately convey the nature of the transaction to the user. Such information may include a transaction date, a transaction amount, a transaction location, a transaction vendor, a description of the goods or services associated with the transaction, and/or any other information associated with a transaction. In many instances, the transaction information 82 and account identifying information 80 may be sufficient for the user to recognize which notification criteria and notification rule or filter triggered the notification message. In other embodiments, the notification message may further include information identifying the notification criteria and/or notification rule or filter that triggered the notification message. One of skill in the art will readily recognize the broad scope of information that may be included in the notification message.

In some embodiments, the notification message may be greatly shortened, and may simply identify that a monitored activity has occurred. In such embodiments, the user may access a free-standing application or a web portal to obtain further details of the events triggering the notification message. In some embodiments, the user may select to receive such notifications to prevent unauthorized knowledge of his or her financial information. In other embodiments, a simplified notification message may be delivered by one method (such as an automated telephone call, text message, pager message, or e-mail), while a more detailed notification message, such as the one illustrated in FIG. 5, may be delivered through a different method or to a different recipient address. As before, in some embodiments, a user may select such options when notification rules are being created.

Although FIG. 5 shows a notification message relating to a single occurrence of account activity relating to a single account, notification messages in accordance with embodiments of the invention may provide multiple activity alerts within a single notification message. This may be done, for example, by the fraud detection service provider as part of a scheduled collection of information from all the user's financial accounts. Rather than access the user's information for a single account and then provide any necessary notification messages for that account, the fraud detection service provider may access the user's information for all the user's accounts at multiple financial institutions before or simultaneously with evaluating the information to determine whether any notification messages should be generated. In such embodiments, once all account information has been obtained and analyzed, a single notification message may be provided to the user containing multiple alerts regarding monitored account activity. As may be appreciated from the above discussion, the account notification messages, such as the one depicted in FIG. 5 may be received in real time or in near-real time with no action taken by the user and without relying on potentially-much-later monthly statements, etc.

Although not specifically illustrated in FIG. 5, in some embodiments, the account notification message may be used to modify the account notification rules or filters. For example, in some embodiments where a user has selected certain notification criteria such as to be notified of all account activity or to be notified of all account activity with a new payee, the account notification message may include one or more links or instructions that modify the account notification rules or filters. One possible link or instruction may allow the user who receives the account notification criteria to approve (and thus prevent the receipt of future account notification messages by modifying the notification filter) all future transactions with a particular payee or vendor. In such embodiments, it may be possible for the notification filters to essentially learn about the user's financial habits and to reduce the number of unnecessary notification messages (those not actually indicative of potential fraud) over time.

FIG. 6 illustrates a different type of notification message, with the illustrated notification message providing a summary of the user's account balances from multiple institutions in a single notification message. As set forth above, such a notification message may also alert a user of fraudulent activity if an account balance changes drastically from what the user expects. The illustrated notification message has a message header 78 as before, notifying the user of the nature of the notification message. The information presented in such a notification message may be presented in any desired order with any desired organization. The illustrated message includes a financial institution identifier 84 for each financial institution being monitored by the fraud detection service provider. The illustrated notification message also includes financial account information 86 that identifies the specific account and the account balance, in a manner similar to that discussed above. The illustrated notification message also includes credit account information 88 under a separate credit heading 90, although such credit account information may also be presented and organized according to financial institution.

One of skill in the art will readily appreciate from the above discussion the many advantages of the embodiments of the invention. One of skill in the art will also readily appreciate the many types of account notification criteria and notification methods that may be used with embodiments of the present invention to alert a user of potential fraud according to user-defined fraud detection criteria in a fast, early, near-real time manner. The present invention is intended to encompass all these notification criteria and methods, and is intended to be applicable to all types of financial accounts, whether or not specifically enumerated herein.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method of receiving notifications of potentially-fraudulent account activity comprising:
establishing user-defined notification criteria governing when a notification of potentially-fraudulent account activity should be generated and delivered to a user, wherein the user-defined notification criteria are established with a fraud detection monitoring service that is monitoring a user financial account at a first financial institution;
monitoring the user financial account for occurrence of the user-defined notification criteria;
generating a notification of potentially-fraudulent account activity upon occurrence of the user-defined notification criteria; and
delivering the notification of potentially-fraudulent account activity to the user.

2. The method of claim 1 wherein establishing user-defined notification criteria comprises:
selecting to establish a new account notification filter;
selecting a first user financial account to which the new account notification filter will be applied from a plurality of user financial accounts at a plurality of financial institutions;
selecting user-defined notification criteria for the new account notification filter; and
selecting one or more user-defined notification methods by which the notification of potentially-fraudulent account activity will be delivered to the user.

3. The method of claim 2 wherein the one or more user-defined notification methods is one or more of an e-mail, a text message, a pager message, a contact by an employee of the fraud detection monitoring service and an automated phone call.

4. The method of claim 1 wherein establishing user-defined notification criteria comprises:
selecting an existing account notification filter to modify;
determining whether to modify the financial account or accounts to which the existing account notification filter will be applied, and if it is determined to modify the financial account or accounts, selecting one or more accounts from a plurality of user financial accounts at a plurality of financial institutions for the existing account notification filter as modified;
selecting user-defined notification criteria for the existing account notification filter as modified; and
selecting one or more notification methods by which the notification of potentially-fraudulent account activity will be delivered to the user.

5. The method of claim 4 wherein selecting user-defined notification criteria comprises at least one of:
adding additional user-defined notification criteria;
deleting user-defined notification criteria; and
modifying existing user-defined notification criteria.

6. The method of claim 1 wherein the fraud detection monitoring service is monitoring a plurality of the user's financial accounts at a plurality of financial institutions, and wherein the user establishes a plurality of user-defined notification criteria so as to receive account notifications from the fraud detection monitoring service for multiple of the plurality of the user's financial accounts at multiple of the plurality of financial institutions.

7. The method of claim 1 wherein the fraud detection monitoring service provides the notification of potentially-fraudulent account activity in near-real time.

8. The method of claim 1 wherein the notification of potentially-fraudulent account activity is delivered by one of an e-mail, a text message, a pager message, a contact by an employee of the fraud detection monitoring service, and an automated phone call.

9. A notification of potentially-fraudulent account activity of a financial account of a user at a financial institution wherein the notification of potentially-fraudulent account activity is provided by a fraud detection monitoring service that is not the financial institution, the notification comprising:
information identifying to the user that a monitored potentially-fraudulent account activity has occurred;
information identifying an account for which the monitored potentially-fraudulent account activity has occurred; and
information identifying the monitored potentially-fraudulent account activity.

10. The notification of activity of claim 9, further comprising information identifying a financial institution of the account.

11. The notification of activity of claim 9 wherein the notification comprises a plurality of alerts of potentially-fraudulent account activity relating to potentially-fraudulent activity for a plurality of financial accounts of the user at a plurality of financial institutions.

12. The notification of activity of claim 9, further comprising an identification of notification criteria used to determine that the notification of potentially-fraudulent account activity should be provided.

13. The notification of activity of claim 9 wherein the financial institution is one of a bank, a lender, a broker, and a credit card provider.

14. The notification of activity of claim 9 wherein the fraud detection monitoring service provides account information compilation services.

15. A system for providing a user with notifications of potentially-fraudulent account activity of the user's financial accounts at a plurality of financial institutions comprising:
a plurality of financial institutions accessible through a network;
a user-defined account notification filter defined by a user having financial accounts at the plurality of financial institutions;
a fraud detection monitoring service providing fraud protection monitoring and notification services, wherein the fraud detection monitoring service is not one of the financial institutions and wherein the fraud detection monitoring service monitors the financial accounts at the plurality of financial institutions for potentially-fraudulent account activity according to the user-defined account notification filter; and
a notification of the occurrence of a potentially-fraudulent event defined by the user-defined account notification filter provided from the fraud detection monitoring service to the user.

16. The system of claim 15 wherein the notification of the occurrence of the potentially-fraudulent event is provided to the user within a brief time after the potentially-fraudulent event occurs.

17. The system of claim 15 wherein the notification of the occurrence of the potentially-fraudulent event is provided to the user by at least one of an e-mail, a text message, a pager message, a direct contact by an employee of the fraud detection monitoring service, and an automated phone call.

18. The system of claim 15 comprising a plurality of user-defined account notification filters used by the fraud detection monitoring service to monitor a plurality of accounts of the user at multiple of the plurality of financial institutions for potentially-fraudulent account activity.

19. The system of claim 15 wherein the notification of the occurrence of the potentially-fraudulent event comprises:
information identifying to the user that a monitored potentially-fraudulent account activity has occurred;
information identifying an account for which the monitored potentially-fraudulent account activity has occurred; and
information identifying the monitored potentially-fraudulent account activity.

20. The system of claim 15 further comprising a user communications device that receives the notification of the occurrence of the potentially-fraudulent event.
